(19) United States
(12) Patent Application Publication
(10) Pub. No.: US 2007/0195019 A1
(43) Pub. Date: Aug. 23, 2007

(54) IMAGE DISPLAY APPARATUS

(76) Inventors: Shinya Ono, Yokohama-shi (JP); Koichi Miwa, Yokohama-shi (JP); Takatoshi Tsujimura, Fujisawa-shi (JP); Yuichi Maekawa, Sagamihara-shi (JP)

Correspondence Address: Frank Pincelli;Patent Legal Staff, Eastman Kodak Company, 343 State Street, Rochester, NY, 14650-2201, US

(21) Appl. No.: 11/671,616

(22) Filed: Feb. 6, 2007

(30) Foreign Application Priority Data
Feb. 21, 2006 (JP) 2006-44584

(51) Int. Cl. G09G 3/30

(52) U.S. Cl. 345/76

(57) ABSTRACT

Active matrix circuitry includes a light emission selection element is disposed between a source electrode of a driver element and an anode of a light emitting element. By turning the light emission selection element off, an electric current of the driver element can be turned off, whereby the threshold voltage of the driver element can be stored in the driver characteristics storage capacitor.

### CROSS REFERENCE TO RELATED APPLICATION

This application claims priority of Japanese Patent Application No. 2006-44584 filed on Feb. 21, 2006, which is incorporated herein by reference in its entirety.

### FIELD OF THE INVENTION

The present invention relates to an active matrix organic EL display apparatus having circuitry used for driving an electroluminescence (EL) element.

### BACKGROUND OF THE INVENTION

Because, unlike liquid crystal display apparatuses, electroluminescence (EL) elements require no backlight, making them suitable for thinner displays, and their viewing angle is not limited, there has been a growing demand for practical organic EL display apparatuses employing self-emissive organic electroluminescence (EL) elements. Organic EL display apparatuses differ from liquid crystal display apparatuses employing liquid crystal cells in which display is controlled by a voltage, in that brightness of light emitted by the organic EL element used therein is controlled by the value of electric current flowing through the EL element.

In general, an active matrix organic EL display apparatus is formed by a set of pixels each composed of three or more sub-pixels, and each sub-pixel has a function of displaying a color of red, blue, green, and so on. These sub-pixels emit light when an electric current in accordance with a predetermined voltage or a greater voltage applied between an anode electrode and a cathode electrode flows therein.

FIG. 5 shows a structure of a conventional active matrix organic EL display apparatus 100. A positive power source voltage supplied from a positive power source supply circuit 105 is applied to each sub-pixel 101 in each pixel 102 by a positive power source line 109. Further, a negative power source voltage supplied from a negative power source supply circuit 106 is applied to each sub-pixel 101 in each pixel 102 by a negative power source line 110. Also, a signal line 107 is provided corresponding to each column of sub-pixels 101 for supplying an electrical signal (a data signal) for display which is supplied from a signal line driving circuit 104 to each sub-pixel 101. In addition, a scan line 108 extending from a scan line driving circuit 103 is provided for each row of sub-pixels 101. In this example, each pixel 102 is composed of three sub-pixels 101 arranged in the row direction.

Each sub-pixel 101 includes a current value control section 115 formed by a switching element 114, an electrostatic capacitor 113, and a driver element 112, and a light emitting element 111.

By setting the scan line 108 to a selection level, the switching element 114 is turned on. The electrostatic capacitor 113 is charged with an electrical signal of the signal line 107 to determine a gate voltage of the driver element 112, so that an electric current in accordance with the gate voltage flows from the positive power source line 109 to the negative power source line 110 via the driver element 112 and the light emitting element 111.

As described above, when each pixel includes three sub-pixels, one pixel includes a total of nine elements. However, disposition of a large number of elements increases the probability of defects occurring.

In order to deal with the above disadvantage, a structure shown in FIG. 6 is proposed. (See. U.S. Patent Application Publication Nos. 2005-0104875A1 and 2005-0140604A1 and Japanese Patent Laid-Open Publication No. 2003-122306, and FIG. 5 of “A 1.8 in. QVGA AMOLED Display with New Driving Method and Ultra Slim Technology” by W-K. Kwak et al, SID 05 Digest pgs. 1448-14-51 and “A 14.1 inch Full Color AMOLED Display with Top Emission Structure and a-Si TFT Backplane” by J. H. Jung et al, SID 05 Digetst, pgs. 1538-1541.

In the structure shown in FIG. 6, a positive power source voltage supplied from a positive power source supply circuit 205 is applied to each pixel 202 by a positive power source line 209. Further, a negative power source voltage supplied from a negative power source supply circuit 206 is applied to each sub-pixel 201 in each pixel 202 by a negative power source line 210. Also, a signal line 207 is provided corresponding to each column of pixels 202 for supplying an electrical signal for display which is supplied from a signal line driving circuit 204 to each pixel 202. In addition, a scan line 208 extending from a scan line driving circuit 203 is provided for each row of pixels 202. In this example, each pixel 202 is formed by including three sub-pixels 201 arranged in the row direction.

Each pixel 202 includes a current value control section 215 formed by a switching element 214, an electrostatic capacitor 213, and a driver element 212, and three sub-pixels 201 connected to the current value control section 215.

Each sub-pixel 201 includes a sub-pixel selection element 216 which functions as a light emission selection element connected to the single driver element 212, and a light emitting element 211. The sub-pixel selection elements 216R, 216G, and 216B of three sub-pixels are sequentially turned on by selection control lines 206R, 206G, and 206B, respectively, extending from the scan line driving circuit 203. Thus, one pixel 202 includes three sub-pixels 201, in each of which a driving current is supplied to the light emitting element 211R, 211G, or 211B via the sub-pixel selection element 216R, 216G, or 216B.

With regard to the circuit shown in FIG. 6, one frame is divided into three sub-frames, as shown in the driving waveform of FIG. 7. In each sub-frame, when the scan line 208 rises to an H level, a signal of the signal line 207 at this time is stored in the electrostatic capacitor 213, and the corresponding electric current flows in the driver element 212 and is then supplied to the sub-pixel 201 selected by the selection control line 206, thereby achieving light emission.

With this structure in which one current value control section 215 is disposed for each pixel 202 and is commonly used by sub-pixels 201 within the pixel, the number of TFTs can be reduced by one and the number of electrostatic capacitors can be reduced by two per one pixel compared to the structure shown in FIG. 5. As such, the number of elements can be reduced and therefore the probability of defects occurring can be lowered.

Here, according to the related technology described above, one frame which is a minimum unit for display of one video image is composed of at least two sub-frames, as shown by the driving waveform of FIG. 7. Each sub-frame displays a single color, and a plurality of sub-frames are sequentially displayed at a high speed for superimposing colors, whereby desired colors and tones are displayed in accordance with the average brightness per unit time.

Further, when the threshold voltage, mobility, or the like of the driver element 212 differ among the pixels 202, the driving current also differs for each pixel even if the data signal is identical. Accordingly, a circuit in which a compensation circuit for compensating for a variation among the driver elements is incorporated, as shown in FIG. 8, has also been proposed (See Japanese Patent Laid Open Publication 2003-122306 and FIG. 5(b) of Kwak et al).

Here, it is important that the sub-pixel selection element 216 be disposed between the current value control section 215 and the light emitting element 211, regardless of whether or not a compensation circuit is provided. Especially when a compensation circuit is incorporated, it is necessary to provide the sub-pixel selection element 216 with not only the function of selecting the sub-pixel 201 but also the function of preventing an electric current from flowing to the light emitting element 211 during detection of the characteristics of the driver element 212 by the compensation circuit. In this regard, by providing a single TFT having these two functions as the sub-pixel selection element, rather than disposing two separate TFTs in order to achieve these two functions, the number of TFTs can be further reduced.

In the circuit shown in FIG. 8, a positive voltage VDD is supplied via a positive power source line 311 to each pixel 300. Further, a negative power source voltage VEE is supplied via a negative power source line 312 to each sub pixel 301 (301a, 301b) of each pixel 300. Also, a signal line Di (i indicates a column number) is provided corresponding to each column of pixels 300 to supply a data signal to each pixel 300. A scan line Sj is also provided for each row of pixels 300. In the shown example, each pixel 300 is formed by including two sub-pixels 301 (301a, 30 1b) arranged in the row direction.

Each pixel 300 includes a switching element 304 and a driver element (p-channel) 305, and a compensation circuit 310, and two sub-pixels 301a and 301 are connected to the driver element 305.

Each of the sub-pixels 301a and 301b includes a sub-pixel selection element 302 (302a, 302b) connected to the single driver element 305, and a light emitting element 303 (303a, 303b). The sub-pixel selection elements 302a and 302b of the two sub pixels are sequentially turned on by the selection control lines E_{j,1} and E_{j,2} (refers to a row number).

The compensation circuit 310 is provided between the switching element 304 and a gate of the driver element 305. One end of the switching element 304 is connected with the signal line Di and the other end of the switching element 304 is connected with the compensation circuit 310. Here, the other end of the switching element 304 is connected with the gate of the driver element 305 via a driver characteristics storage capacitor 308 and is also connected with the positive power source line 311 by means of a switching TFT 307 and a brightness signal storage capacitor 309. Further, the gate of the driver element 305 is connected to a connection point between the driver element 305 and the sub-pixels 301a and 301b via a switching TFT 306. In addition, a reset line Rj is connected to the gate of the switching TFT 307 and the gate of the switching TFT 306.

In order to explain the role of the sub-pixel selection element 302 in a pixel circuit in which the compensation circuit 310 is incorporated as described above, the operation of the pixel circuit shown in FIG. 8 will be described with reference to timing charts shown in FIG. 9. At a time before time A in FIG. 9, the potential of the reset signal line R is set such that the two switching TFTs 306 and 307 are in a conducting state. Consequently, electrodes at both ends of the brightness signal storage capacitor 309 are reset, and as the sub-pixel selection element 302a is in a conducting state, the potential of the gate of the driver element 305 becomes sufficiently lower than the potential of the positive power source line 311 and the potential difference at this time is stored at both ends of the driver characteristics storage capacitor 308. Then, at the time A, while the both sub-pixel selection TFTs 302a and 302b are placed in a non-conducting state, the driver element 305 remains in a conducting state because a sufficiently high voltage is applied between the source and the gate of the driver element 305 by the driver characteristics storage capacitor 308. However, an electric current flowing from the positive power source line 311 via the driver element 305 is supplied to the driver characteristics storage capacitor 308 via the switching TFT 306 and thus raises the gate potential of the driver element 305. Then, when the potential difference at the source-gate of the driver element 305 equals the threshold voltage Vth of the driver element 305, the driver element 305 is placed to a non-conducting state, and consequently the threshold voltage of the driver element 305 is recorded in the driver characteristics storage capacitor 308. Then, after placing the switching TFTs 306 and 307 in a non-conducting state, the switching TFT 304 is placed in a conducting state at time B and a brightness voltage (data) signal Vdata corresponding to the light emitting element 303a to be selected in that sub-frame is recorded in the brightness signal storage capacitor 309. As a result, the potential of the gate of the driver element 305 becomes (Vdata−Vth), and therefore the value of the electric current flowing in the light emitting element 303a in the period between C and D is I=β(VDD−Vdata)², which does not depend on Vth. Here, the value of β depends on the mobility, shape, and the like of the driver TFT.

Again, what is important is the fact that the sub-pixel selection TFT 302 has two functions: a function of preventing an electric current from flowing in the light emitting element 303 at the time of detecting the threshold voltage and a function of selecting either the light emitting element 303a or the light emitting element 303b to which an electric current controlled by the current value control section 300 is applied during the light emission period. In particular, in order to achieve the selection control, it is necessary to dispose the sub-pixel selection TFT 302 between the current value control section 300 and the light emitting element 303.

Circuit structures forming active matrix organic EL display apparatuses can be classified into two types: a cathode common structure in which cathode electrodes of all the light emitting elements are connected to a negative power source line and anode electrodes are connected to a pixel circuit and an anode common structure in which anode electrodes of all the light emitting elements are connected to a positive power source line and cathode electrodes are connected to a pixel circuit. Which of these types should be selected may depend on the process steps for manufacturing a display apparatus and the device structure of the light emitting element.

Here, a pixel circuit in which a plurality of sub-pixels are connected to a single driver element as shown in FIG. 8 is assumed using a circuit having a cathode common structure which is formed only of N-channel amorphous silicon TFTs shown in Reference 5. In this case, as a current blocking TFT 313 is required when detecting a threshold voltage as shown in FIG. 10, the number of necessary TFTs is increased by one compared to the structure shown in FIG. 8, which makes it difficult to achieve the advantage of increased yield. Further, the structure of three TFTs connected in series with respect to the light emitting element causes a problem of increase in power consumption.

### SUMMARY OF THE INVENTION

It is an object of the present invention to provide an active matrix apparatus comprising:

a driver element having a drain electrode connected to a positive power source line;

a light emission selection element having a drain electrode connected to a source electrode of the driver element and a gate electrode connected to a light emission control line;

a light emitting element having an anode electrode connected to a source electrode of the light emission selection element and a cathode electrode connected to a negative power source line, the light emitting element capable of emitting light when an electric current is directed therethrough;

a signal selection element having a drain electrode or a source electrode connected to a signal line which transmits a brightness signal and a gate electrode connected to a scan line;

a driver characteristics storage capacitor having a first electrode connected to a gate electrode of the driver element and a second electrode connected to the source electrode or the drain electrode of the signal selection element; and

a first switching element having one of a drain electrode or a source electrode thereof connected to the drain electrode of the driver element, the other of the source electrode or the drain electrode thereof connected to the gate electrode of the drive element, and a gate electrode connected to a reset line.

### BRIEF DESCRIPTION OF THE DRAWINGS

Preferred embodiments of the present invention will be described in detail based on the following figures, wherein:

FIG. 1 is a diagram showing a structure of a first embodiment of the present invention;

FIG. 2 is a timing chart of the first embodiment;

FIG. 3 is a diagram showing a structure of a second embodiment of the present invention;

FIG. 4 is a timing chart of the second embodiment;

FIG. 5 is a diagram showing a structure of a first related art example;

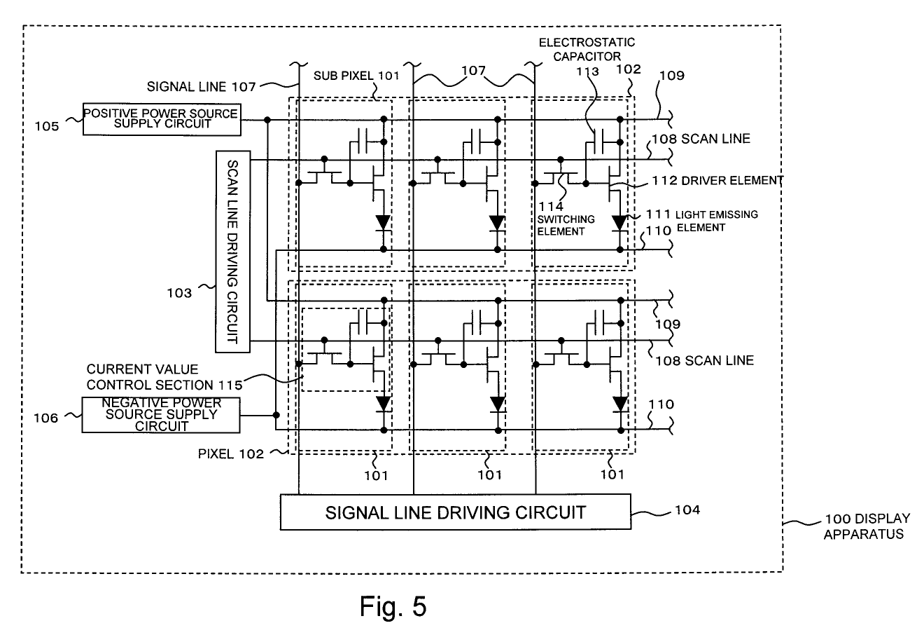

FIG. 6 is a diagram showing a structure of a second related art example;

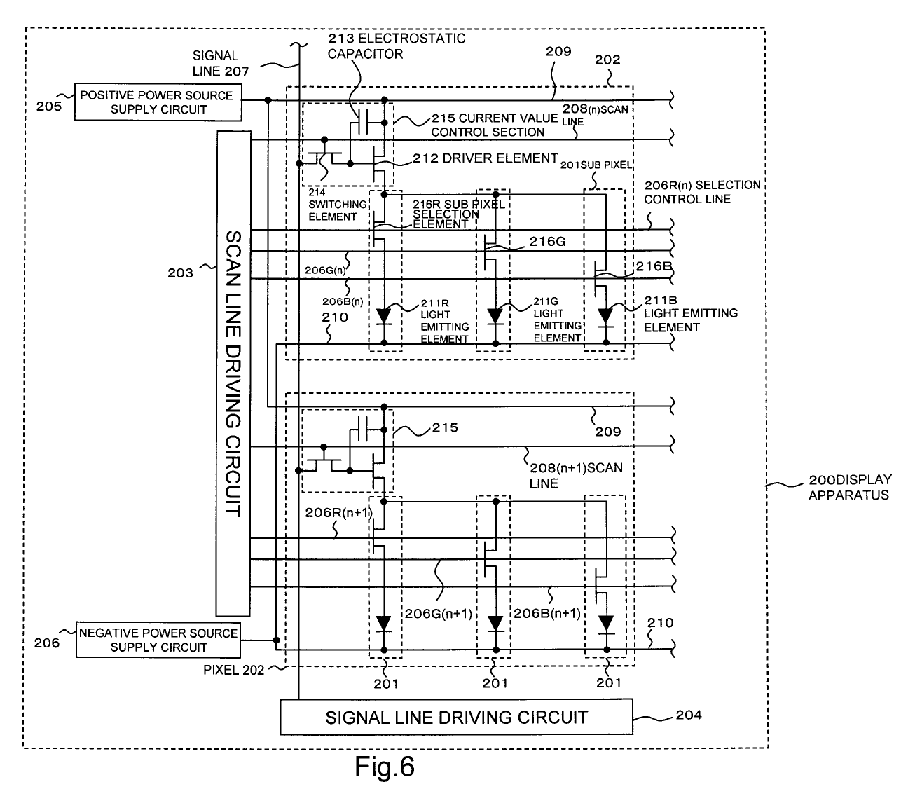

FIG. 7 is a timing chart of the second related art example;

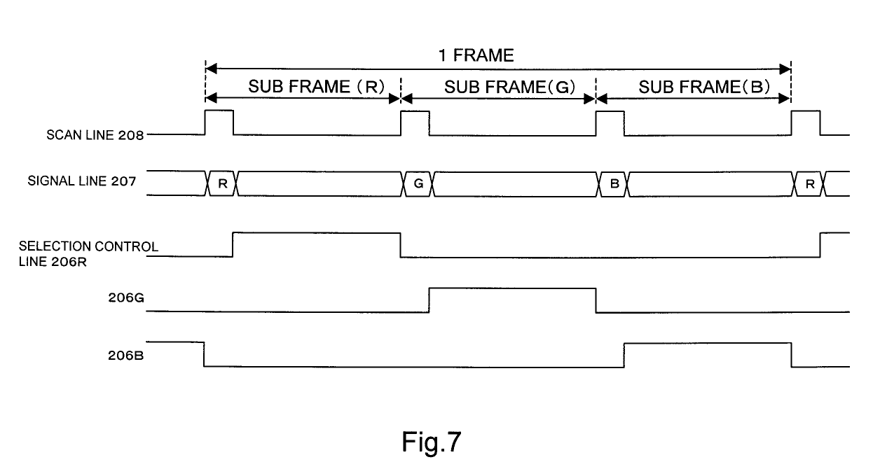

FIG. 8 is a diagram showing a structure of a third related art example;

FIG. 9 is a timing chart of the second related art example; and

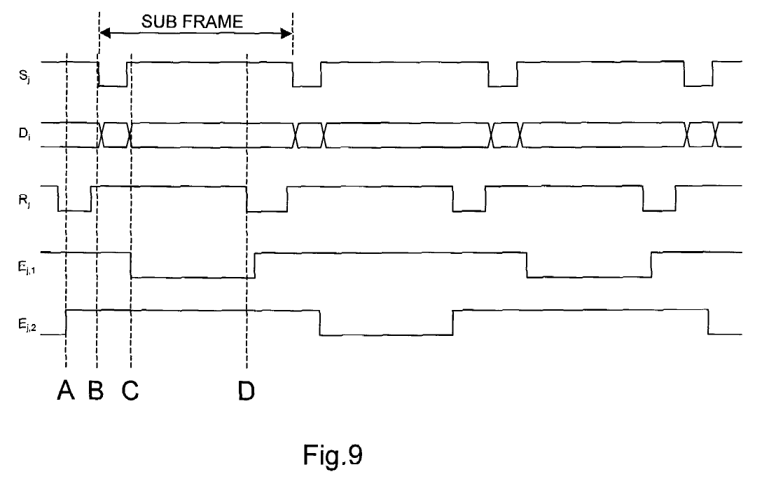

FIG. 10 is a diagram showing a structure of a fourth related art example.

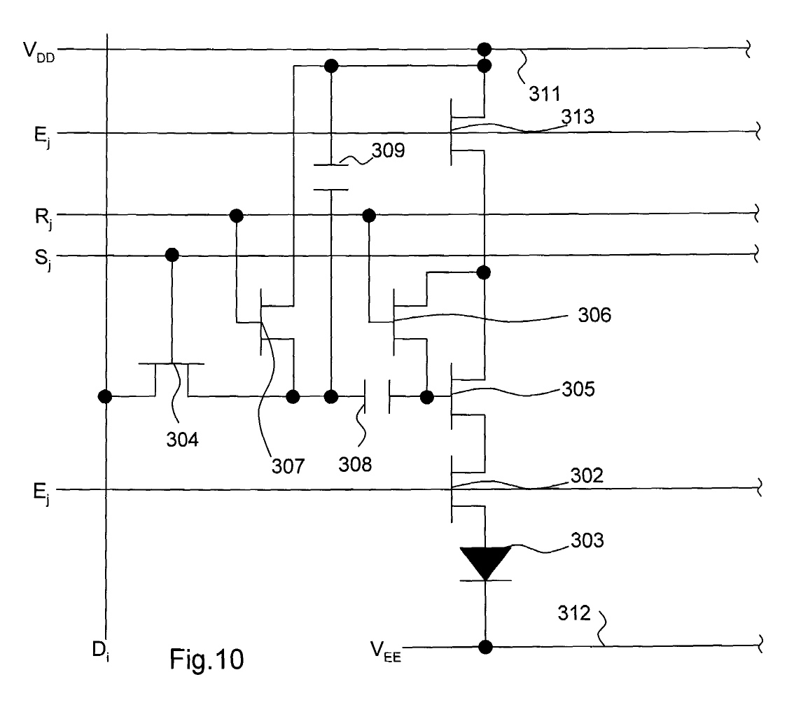

### DETAILED DESCRIPTION

Preferred embodiments of the present invention will be described in detail with reference to the accompanying drawings. It should be noted, however, the scope of the invention is not limited to the illustrated examples.

### Embodiment 1

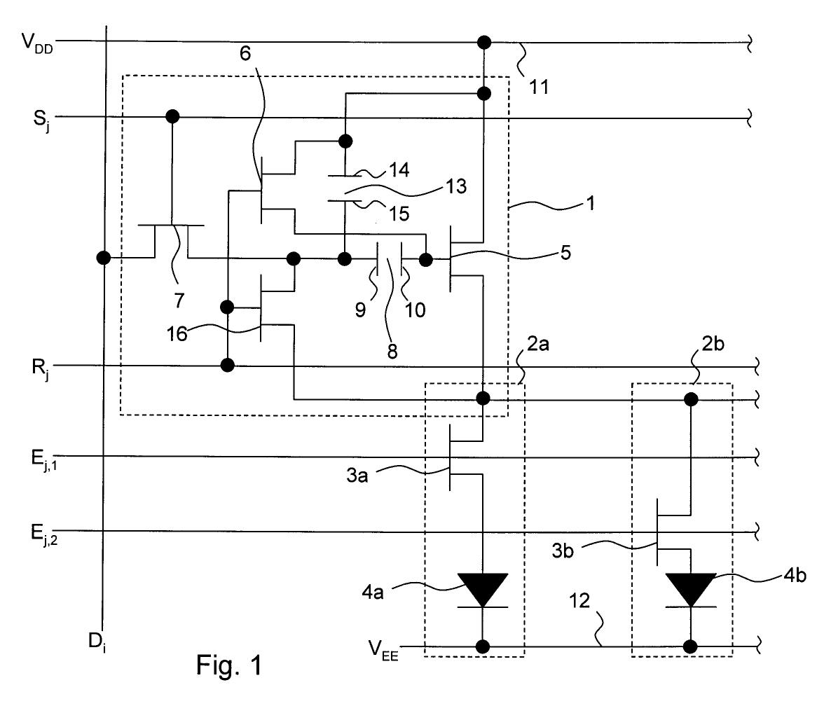

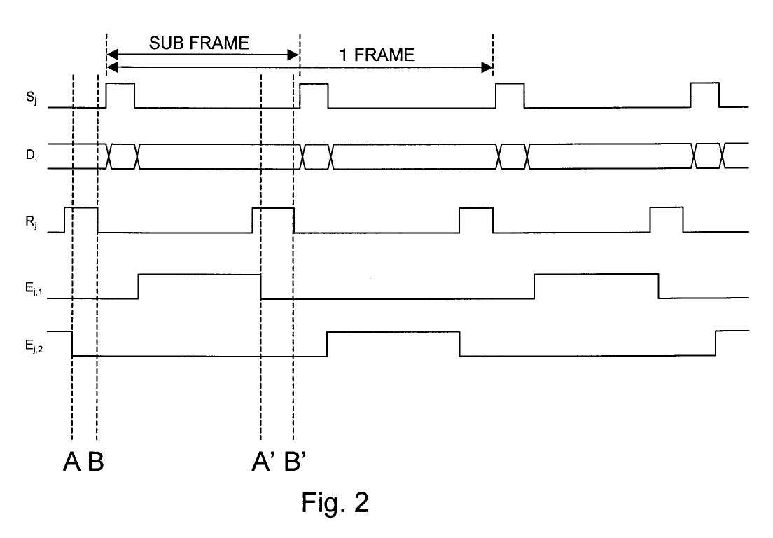

FIG. 1 shows a structure of a first embodiment according to the present invention, and FIG. 2 is a timing chart of the circuit shown in FIG. 1. In this embodiment, a current value control section 1 has an effect of reducing the sensitivity of a driver element 5 to a threshold voltage variation among pixels. Further, FIG. 1 shows a pixel circuit located in the j-th row and the i-th column, and N-channel TFTs are used for all the transistors in this circuit structure.

One of a source electrode and a drain electrode of a signal selection element 7 having a gate electrode connected to a scan line Sj is connected to a signal line Di. The other of the source and drain electrodes of the signal selection element 7 is connected with a second electrode 9 of a TFT characteristics storage capacitor 8, a first electrode 10 of which is connected with a gate electrode of the driver element 5.

Further, one of a drain electrode and a source electrode of a first switching element 6 is connected to a positive power source line 11, and the other of the drain and source electrodes of the first switching element 6 is connected to the gate electrode of the driver element 5. A reset line Rj is connected to a gate electrode of the first switching element 6. One of a drain electrode and a source electrode of a second switching element 16 having a gate electrode connected with the reset line Rj is connected with a connection point between the signal selection element 7 and the second electrode 9 of the TFT characteristics storage capacitor 8, and the other of the drain and source electrodes of the second switching element 16 is connected with a connection point between the driver element 5 and a sub pixel 2 (2a, 2b). Further, a second electrode 15 of a brightness signal storage capacitor 13 is connected to a connection point between the signal selection element 7 and the TFT characteristics storage capacitor 8, and a first electrode 14 of the brightness signal storage capacitor 13 is connected with the positive power source line 11 (the drain electrode of the driver element 5).

Prior to writing a brightness voltage signal to the current value control section 1 by means of the signal line Di, at a time before time A in FIG. 2, a signal of the reset line Rj is set to a potential (in this case, H level) which places the first switching element 6 and the second switching element 16 in a conducting state.

Thus, the first and second switching elements 6 and 16 are turned on, and a voltage of the positive power source line 11 is set at the first electrode 10 of the TFT characteristics storage capacitor 8 and a voltage connected to the sub-pixel 2 is set to the second electrode 9 of the TFT characteristics storage capacitor 8. Consequently, a potential difference which is larger than the threshold voltage between the gate and the source of the drive element 5 is stored between the electrodes 9 and 10 of the TFT characteristics storage capacitor 8.

Subsequently, the potential of the selection control lines E (j, k) is set to a potential which turns all the sub-pixel selection elements 3 (3a, 3b) in the j-th row off. In this state, because the potentials of the drain and the gate of the driver element 5 are identical and the potential difference which is larger than the gate-source threshold voltage of the driver element is generated at the TFT characteristics storage capacitor 8, the driver element 5 is in a conducting state. However, because all the sub-pixel selection elements 3 are turned off, no electric current flows through the light emitting elements 4. As a result, the source potential of the driver element 5 increases, and when the gate-source potential of the driver element 5 equals the threshold voltage of the driver element 5, the driver element 5 is turned off. Namely, the threshold voltage of the driver element 5 is recorded in the TFT characteristics storage capacitor 8.

Then, with the reset line Rj being set to a potential (L level) which places the first switching element 6 and the second switching element 16 in a non-conducting state, and the scan line Sj being set to a potential which places the signal selection element 7 in a conducting state, a brightness signal (electrical signal) voltage supplied from the signal line Di is recorded in the brightness signal storage capacitor 13 via the signal selection element 7. At this time, because the threshold voltage of the driver element is held at both ends of the TFT characteristics storage capacitor due to the threshold voltage detection process described above, the gate voltage of the driver element 5 has a value obtained by adding the threshold voltage of the driver element 5 to the brightness signal voltage which is recorded.

Subsequently, with the scan line Sj being set to a potential (L level) which puts the signal selection element 7 in a non-conducting sate and one or more (typically one) of the selection control lines E (j, k) being selected, one or more (typically one) of the light emitting elements 4 (4a, 4b) is placed in a light emitting state.

The value of the current id flowing in the driver element 5 at this time can be represented by the following expression:

id=(β/2) (Vgs−Vth)²

In the above expression, β is a value which is determined by the mobility, the shape, and the material of the driver element 5, Vgs is a potential between the gate and the source of the driver element 5, and Vth is the threshold voltage of the driver element 5.

As described above, the value of the gate potential of the drive element 5 is a value obtained by adding the threshold voltage of the driver element 5 to the brightness signal voltage. Therefore, when the brightness signal voltage is represented by Vdata, the following equation

Vg=Vdata+Vth

can be obtained. Consequently, the current id can be represented by the following expression.

Id=(β/2)(Vdata−Vo)²

Thus, the current value id does not depend on the threshold voltage of the driver element 5, so that the display quality can be increased. Here, Vo is a source potential of the driver element 5 when the light emitting element 4 emits light.

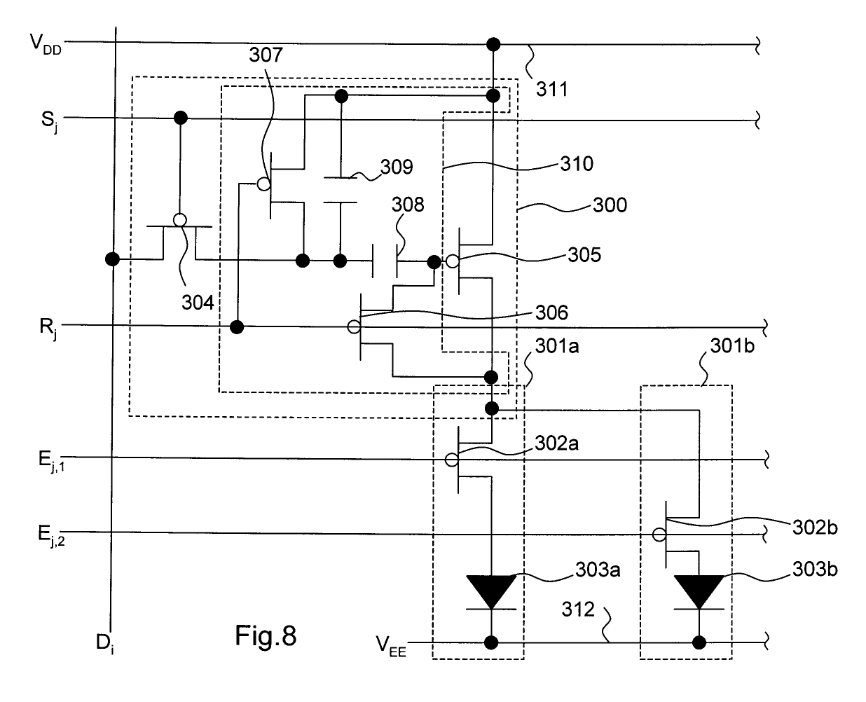

With the above structure, by turning the sub-pixel selection element 3 off, the electric current of the driver element 5 can be turned off and the threshold voltage of the driver element 5 can be stored in the TFT characteristics storage capacitor 8. Consequently, even when the signal selection element 7, the first and second switching elements 6 and 16, the driver element 5, and the sub-pixel selection elements 3 are formed by N-channel TFTs, it is not necessary to provide a switching element for turning the electric current of the driver element off. It is therefore possible to form a pixel circuit using amorphous silicon TFTS with the same number of elements as the number of elements in the pixel circuit using P-channel TFTs shown in FIG. 8.

### Embodiment 2

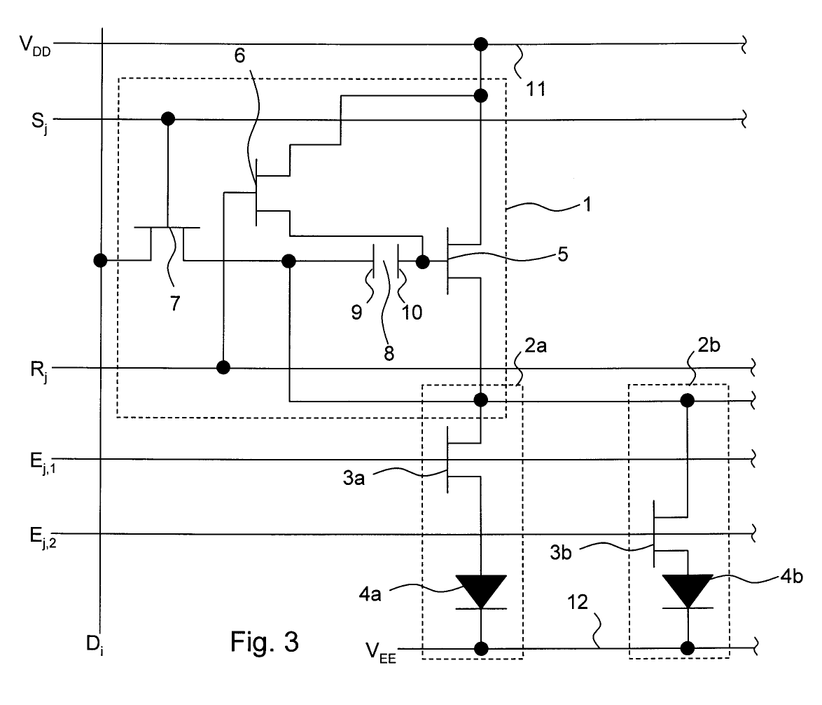

FIG. 3 shows another embodiment to which the present invention is applied. This pixel circuit has an effect of reducing the sensitivity of the driver element 5 to a variation of β, in addition to a variation of the threshold voltages, among the pixels.

As shown in FIG. 3, the end of the signal selection element 7 opposite to the end connected to the signal line Di is connected with the end (source electrode) of the driver element 5 which is connected to the sub pixel 2. This end of the signal selection element 7 opposite to the signal line Di is also connected with the second electrode 9 of the TFT characteristics storage capacitor 8, the first electrode 10 of which is connected to the gate electrode of the driver element 5. Further, the positive power source line 11 and the gate of the driver element 5 are connected via the first switching element 6, and the gate of the first switching element 6, similar to the gate of the signal selection element 7, is connected to the scan line Sj or the reset lint Rj (to the reset line Rj in the example shown in FIG. 3).

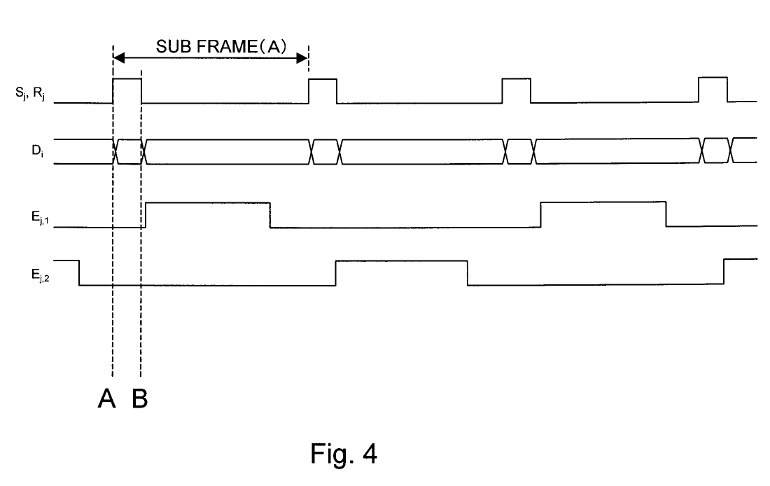

Prior to the timing A in FIG. 4, the potential of the selection control lines E (j,k) is set to a potential which places all the sub-pixel selection elements 3 in the j-th row in a non-conducting state. Then, with the scan line Sj being set to a potential (H level) which puts the signal selection element 7 and the first switching element 6 in a conducting state, a brightness signal current is caused to flow via the signal line Di. At this time, because the first switching element 6 is turned on, the gate potential and the drain potential of the driver element 5 are identical, to allow the brightness signal current to flow in the driver element 5. Consequently, when the brightness signal current is represented by i_{data}, the voltage represented by the following expression is generated between the gate and the source of the driver element 5:

Vgs=Vth+√(2i_{data}/β)

Subsequently, the scan line Sj is set to a potential (L level) which puts the signal selection element 7 and the first switching element 6 in a non-conducting state, and one or more (typically one) of the selection control lines E (j,k) is selected to place one or more of the light emitting elements 4 in a light emitting state. At this time, the value of current id flowing in the driver element 5 can be represented by the following expression:

Id=(β/2)(Vgs−Vth)²=i_{data}

As such, with the use of the pixel circuit shown in FIG. 3, as in the above example, the current value id does not depend on the threshold value Vth and β of the driver element 5, so that the display quality can be increased.

While the preferred embodiments of the present invention have been described using specific terms, such description is for illustrative purposes only, and it is to be understood that changes and variations may be made without departing from the spirit or scope of the appended claims.

### PARTS LIST

current value control section
2 sub-pixel
2a sub-pixel
2b sub pixel
3 sub-pixel selection element
3a sub-pixel selection element
3b sub-pixel selection element
4 light emitting elements
4a light emitting elements
4b light emitting elements
5 driver element
6 switching element
7 signal selection element
8 storage capacitor
9 second electrode
10 first electrode
11 positive power source line
13 storage capacitor
14 first electrode
15 second electrode
16 second switching element
100 organic EL display
101 sub-pixel
102 pixel
105 power source supply circuit
106 negative power source supply circuit
107 signal line
108 scan line
109 positive power source line
110 negative power source line
111 light emitting element
112 driver element
113 electrostatic capacitor
114 switching element
115 current value control section
201 sub-pixel
202 pixels
203 scan line driving circuit
204 signal driving circuit
205 positive power source supply circuit
206 negative power source supply circuit
206R selection control line
206G selection control line
206B selection control line
207 signal line
208 scan line
209 positive power source line
210 negative power source line
211 light emitting element
211R light emitting element
211G light emitting element
211B light emitting element
212 driver element
213 electrostatic capacitor
214 switching element
215 current value control section
216 sub-pixel selection element
216G sub-pixel selection element
216R sub-pixel selection element
216B sub-pixel selection element
300 pixel
301 sub-pixel
301a sub-pixel
301b sub-pixel
302a sub-pixel selection element
302b sub-pixel selection element
302 sub-pixel TFT
303 light emitting element
303a light emitting element
303b light emitting element
304 switching element
305 driver element
306 switching TFT
307 switching TFT
308 storage capacitor
309 storage capacitor
310 compensation circuit
311 positive power source line
312 negative power source line
313 current blocking TFT

1. An active matrix apparatus comprising:
a driver element having a drain electrode connected to a positive power source line;
a light emission selection element having a drain electrode connected to a source electrode of the driver element and a gate electrode connected to a light emission control line;
a light emitting element having an anode electrode connected to a source electrode of the light emission selection element and a cathode electrode connected to a negative power source line, the light emitting element capable of emitting light when an electric current is directed therethrough;
a signal selection element having a drain electrode or a source electrode connected to a signal line which transmits a brightness signal and a gate electrode connected to a scan line;
a driver characteristics storage capacitor having a first electrode connected to a gate electrode of the driver element and a second electrode connected to the source electrode or the drain electrode of the signal selection element; and
a first switching element having one of a drain electrode or a source electrode thereof connected to the drain electrode of the driver element, the other of the source electrode or the drain electrode thereof connected to the gate electrode of the drive element, and a gate electrode connected to a reset line.

2. An active matrix apparatus according to claim 1, comprising:
a brightness voltage storage capacitor having a first electrode connected to the positive power source line and a second electrode connected to the second electrode of the driver characteristics storage capacitor; and
a second switching element having one of a source electrode or a drain electrode connected to the second electrode of the brightness voltage storage capacitor, the other of the drain electrode or the source electrode connected to the source electrode of the driver element, and a gate electrode connected to the reset line.

3. An active matrix apparatus according to claim 1, wherein the source electrode of the driver element is connected to the second electrode of the driver characteristics storage capacitor.

4. An active matrix apparatus according to claim 1, wherein:
in a state where the first switching element is turned on by the reset line and the light emission selection element is turned off, a threshold voltage of the driver element is generated at the second electrode of the driver characteristics storage capacitor.

5. An active matrix apparatus according to claim 4, wherein
the scan line and the reset line are driven with an identical waveform.

6. An active matrix apparatus according to claim 1, wherein the driver element is a thin film transistor.

7. An active matrix apparatus according to claim 6, wherein:
the thin film transistor is an amorphous silicon transistor.

8. An active matrix apparatus according to claim 1, wherein:
one or more light emission selection elements are connected to the source electrode of the driver element,
the light emitting element is connected to each of the one or more light emission selection elements, and
an electric current flowing in the driver element is supplied to the one or more light emitting elements.

9. An active matrix apparatus according to claim 1, wherein the one or more light emission selection elements are connected to different light emission control lines, respectively, and are turned on at different times.

10. An active matrix apparatus according to claim 1, wherein the light emitting element is an organic electroluminescence element.
